(19) United States
(12) Patent Application Publication
(10) Pub. No.: US 2016/0176239 A1
(43) Pub. Date: Jun. 23, 2016

(54) PNEUMATIC TIRE

(71) Applicant: TOYO TIRE & RUBBER CO., LTD., Osaka (JP)

(72) Inventor: Ichiro Shima, Osaka-shi (JP)

(73) Assignee: TOYO TIRE & RUBBER CO., LTD., Osaka (JP)

(21) Appl. No.: 14/966,167

(22) Filed: Dec. 11, 2015

(30) Foreign Application Priority Data
Dec. 17, 2014 (JP) 2014-255378

(51) Int. Cl. B60C 13/02; B60C 9/02; B60C 11/00; B60C 9/18

(52) U.S. Cl. CPC B60C 13/02; B60C 9/185; B60C 9/02; B60C 9/18; B60C 11/0008; B60C 2009/1878

(57) ABSTRACT

In a pneumatic tire, side wall rubbers have protruding portions which protrude toward outward sides in the tire width direction, a dimension in the tire diametrical direction of the protruding portion is equal to or less than a dimension in the tire diametrical direction of the cushion rubber, the protruding portions are arranged so as to overlap with the cushion rubbers in the tire width direction at least partly, and outer ends in the tire diametrical direction of the protruding portions are arranged at the same positions as outer ends in the tire diametrical direction of the cushion rubbers or closer to inner sides in the tire diametrical direction than the outer ends in the tire diametrical direction of the cushion rubbers.

### CROSS REFERENCE TO RELATED APPLICATIONS

This application claims the benefit of priority under 35 USC 119 of Japanese application no. 2014-255378, filed on Dec. 17, 2014, which is incorporated herein by reference.

### BACKGROUND OF THE INVENTION

1. Field of the Invention

The present invention relates to a pneumatic tire having a cushion rubber which is arranged between an end portion in an outward side in a tire width direction of a belt layer and a carcass layer.

2. Description of the Related Art

Conventionally, there has been known a pneumatic tire having a carcass layer which is arranged along a tire inner periphery, and a belt layer which is arranged in an outer side in a tire diametrical direction of the carcass layer (for example, JP-A-04-5109). Further, the pneumatic tire is provided with a cushion rubber which is arranged between an end portion in an outward side of a tire width direction of the belt layer and the carcass layer.

Although not being described in the above patent document, a low heat build-up rubber is used for the cushion rubber, for example, in the case of inhibiting the belt layer from becoming high temperature. Further, in the case of inhibiting the cushion rubber front being separated from the carcass layer and the belt layer or the like, a rubber having an adhesion property is used for the cushion rubber.

Meanwhile, the rubber having the low heat build-up and having the adhesion property is generally a rubber having a low modulus. Further, in a case where the cushion rubber is the rubber having the low modulus, steering stability (particularly the steering stability at the turning time) is lowered.

### SUMMARY OF THE INVENTION

Accordingly, the present invention has been made by taking the circumstances into consideration, and an object of the present invention is to provide a pneumatic tire which can improve steering stability while inhibiting a rolling resistance from increasing.

There is provided a pneumatic tire which includes:

a carcass layer which is arranged along a tire inner periphery;

a belt layer which is arranged in an outer side in a tire diametrical direction of the carcass layer;

a tread rubber which has a cap rubber constructing a tread surface and is arranged in an outer side in the tire diametrical direction of the belt layer;

side wall rubbers whose end portions in outward sides in the tire diametrical direction are connected to end portions in outward sides in a tire width direction of the tread rubber; and

cushion rubbers which are arranged between end portions in outward sides in the tire width direction of the belt layer and the carcass layer, and have a smaller modulus than a modulus of the cap rubber,

wherein the side wall rubber has protruding portion which protrudes toward outward side in the tire width direction,

a dimension in the tire diametrical direction of the protruding portion is equal to or less than a dimension in the tire diametrical direction of the cushion rubber,

the protruding portion is arranged so as to overlap with the cushion rubber in the tire width direction at least partly, and

outer end in the tire diametrical direction of the protruding portion is arranged at the same position as outer end in the tire diametrical direction of the cushion rubber or closer to inner side in the tire diametrical direction than the outer end in the tire diametrical direction of the cushion rubber.

Also the pneumatic tire may have a configuration in which:

end portion in outward sides in the tire diametrical direction of the side wall rubber is piled up to end portion in outward side in the tire width direction of the tread rubber from outer side in the tire width direction, and

inner end in the tire diametrical direction of the protruding portion is arranged at the same position as inner end in the tire diametrical direction of the tread rubber or closer to outer side in the tire diametrical direction than the inner end in the tire diametrical direction of the tread rubber.

Also the pneumatic tire may have a configuration in which:

the protruding portion is arranged so as to overlap with the cushion rubber in the tire width direction in their entirety.

Also the pneumatic tire may have a configuration in which:

the protruding portion is provided with a plurality of first convex portions which are arranged in parallel along a tire peripheral direction, and a second convex portion which extends along the tire peripheral direction and is connected to the plurality of first convex portions.

Also the pneumatic tire may have a configuration in which:

the side wall rubber is provided with a side groove which extends along the tire diametrical direction from the outer end in the tire diametrical direction, and

the first convex portions are connected to an inner end in the tire diametrical direction of the side groove.

Also the pneumatic tire may have a configuration in which:

the second convex portion is connected to inner ends in the tire diametrical direction of the first convex portions, and is arranged so as to overlap with an inner end in the tire diametrical direction of the cushion rubber in the tire width direction.

As mentioned above, the pneumatic tire according to the present invention achieves an excellent effect that the pneumatic tire can improve the steering stability while inhibiting the rolling resistance from increasing.

### BRIEF DESCRIPTION OF THE DRAWINGS

FIG. 1 is a view of a substantial part of a pneumatic tire according to an embodiment and is a cross sectional view in which the pneumatic tire is cut along a tire diametrical direction;

FIG. 2 is an enlarged view of an area II in FIG. 1;

FIG. 3 is a side elevational view of a substantial part of the pneumatic tire according to the embodiment;

FIG. 4 is an enlarged view of the area II in FIG. 1 and is a view illustrating a position of a protruding portion;

FIG. 5 is an enlarged cross sectional view of a substantial part of a pneumatic tire according to another embodiment, and is a view illustrating a position of a protruding portion; and

FIG. 6 is an evaluation table between examples and comparative examples.

### DETAILED DESCRIPTION OF THE PREFERRED EMBODIMENTS

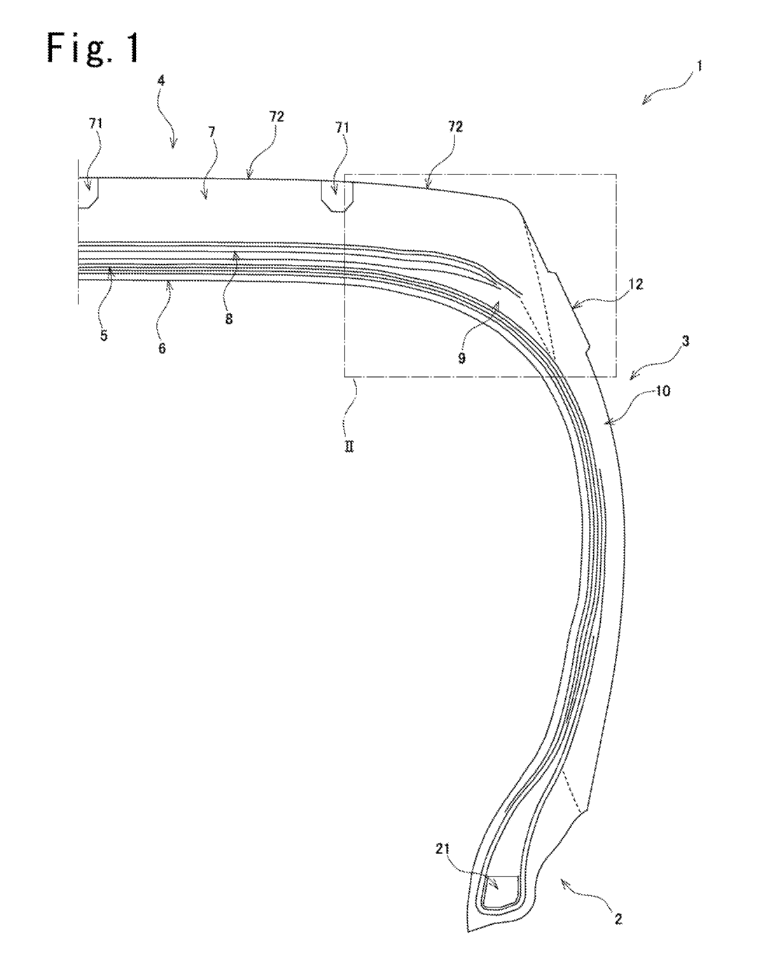

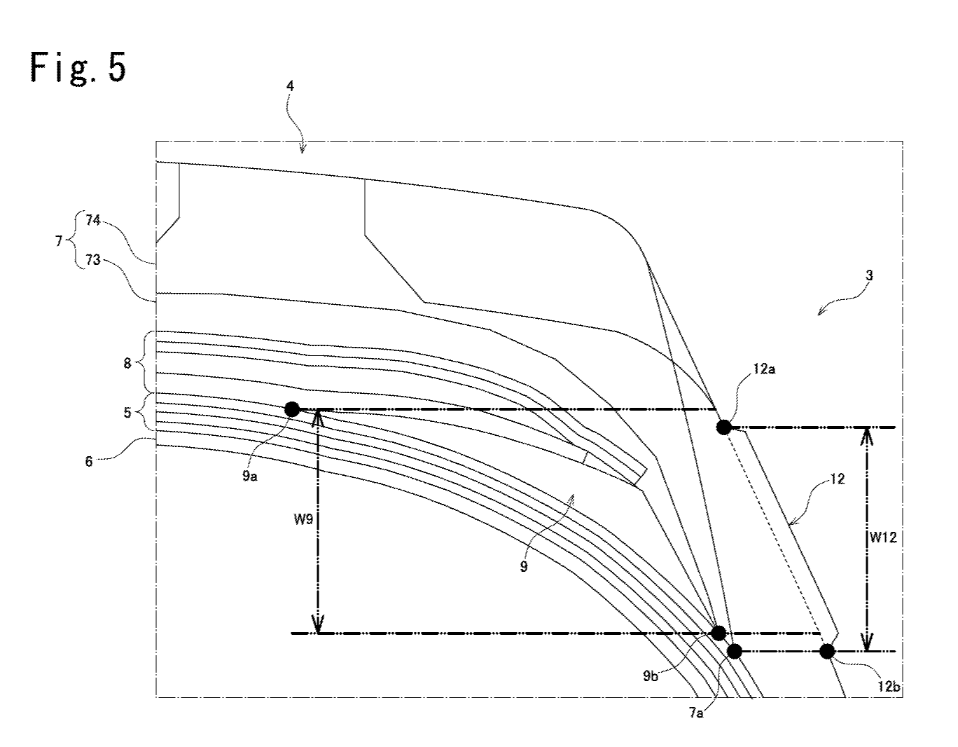

A description will be given below of an embodiment in a pneumatic tire with reference to FIGS. 1 to 4. In each of the drawings (the same applies to FIG. 5), dimensional ratios of the drawings do not necessarily coincide with actual dimensional ratios.

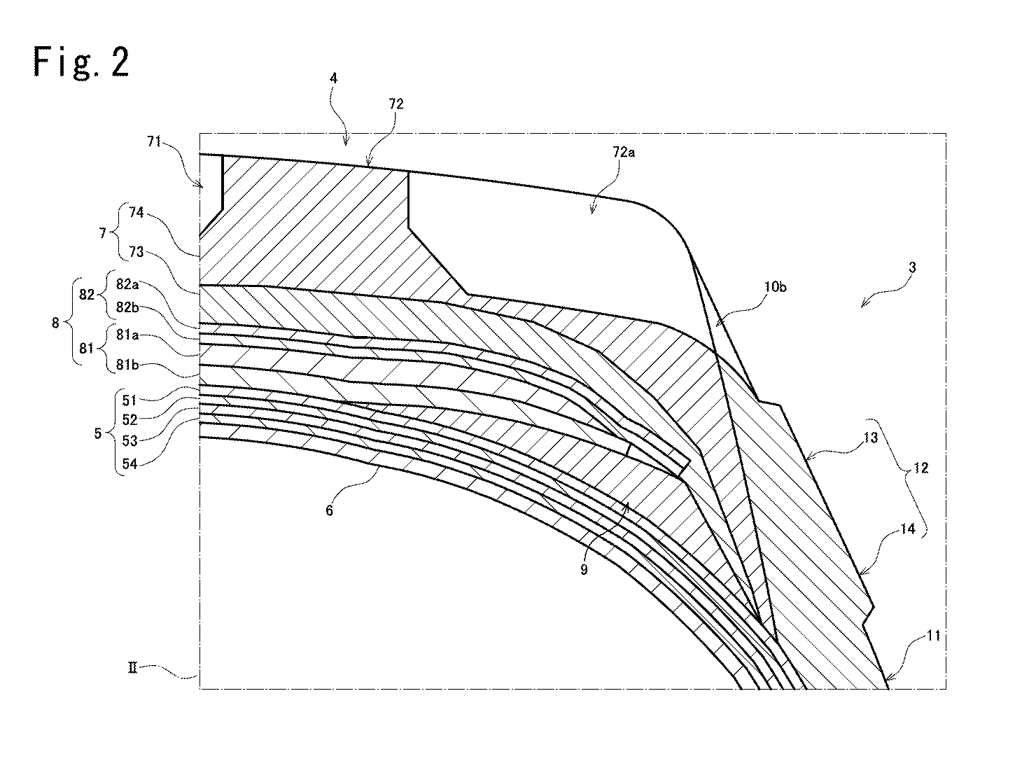

As shown in FIGS. 1 and 2, a pneumatic tire (hereinafter, also referred simply to as “tire”) 1 according to the present embodiment is provided with a pair of bead portions 2 which have beads 21, side wall portions 3 which extend in an outer side in a tire diametrical direction from the respective bead portions 2, and a tread portion 4 which is connected to end portions in outward sides in the tire diametrical direction of a pair of side wall portions 3 and constructs a tread surface. The tire 1 is installed to a rim (not shown).

The tire 1 is provided with a carcass layer 5 which is bridged between a pair of beads 21 and 21 and is wound up from an inner side to an outer side in a tire width direction so as to enwrap the beads 21, and an inner liner rubber 6 which is arranged in an inner side of the carcass layer 5 and is excellent in a function of inhibiting air from going through for retaining a pneumatic pressure. The carcass layer 5 and the inner liner rubber 6 are arranged along a tire inner periphery over the bead portions 2, the side wall portions 3 and the tread portion 4.

The carcass layer 5 is constructed by four carcass plies 51 to 54 in the present embodiment. Further, the carcass plies 51 to 54 are provided with a plurality of ply cords arranged in a direction which is approximately orthogonal to a tire peripheral direction, and a topping rubber which covers the ply cords. An organic fiber such as polyester, rayon, nylon or aramid is used for the ply cord.

The tread portion 4 is provided with a tread rubber 7 which is arranged in an outer side in a tire diametrical direction of the carcass layer 5 for constructing a tread surface (a ground surface) which comes into contact with a land surface. Further, the tread portion 4 is provided with a belt portion 8 which is arranged in an outer side in the tire diametrical direction of the carcass layer 5 and in an inner side in the tire diametrical direction of the tread rubber 7, and a cushion rubber 9 which is arranged between the carcass layer 5 and the belt portion 8.

The tread rubber 7 is provided with a plurality of peripheral grooves 71 which extend along a tire peripheral direction. Further, the tread rubber 7 is provided with a plurality of land portions 72 which is comparted by a plurality of peripheral grooves 71. In the present embodiment, three peripheral grooves 71 are provided, and four land portions 72 are accordingly provided.

Further, the tread rubber 7 is provided with a base rubber 73 which is arranged in an outer side in the tire diametrical direction of the belt portion 8, and a cap rubber 74 which is arranged in an outer side in the tire diametrical direction of the base rubber 73 and constructs the tread surface. The base rubber 73 is arranged so as to cover the belt portion 8 and the cushion rubber 9, and the cap rubber 74 is arranged so as to cover the base rubber 73. A modulus of the cap rubber 74 is larger than a modulus of the base rubber 73.

The belt portion 8 is provided with a belt layer 81 which is arranged in an outer side in the tire diametrical direction of the carcass layer 5 for reinforcing the carcass layer 5. Further, the belt portion 8 is provided with a belt reinforcing portion 82 which is arranged in an outer side in the tire diametrical direction of the belt layer 81 and in an inner side in the tire diametrical direction of the tread rubber 7 for reinforcing the belt layer 81.

The belt layer 81 is provided with at least two layers of belt plies 81a and 81b. In the present embodiment, the belt layer 81 is provided with two layers of belt plies 81a and 81b. Each of the belt plies 81a and 81b is provided with a plurality of belt cords which are arranged in parallel, and a topping rubber which covers the belt cords.

Further, the belt plies 81a and 81b are laminated in such a manner that the belt cords arranged at a predetermined angle of incline (for example, between 15 degrees and 35 degrees) in relation to the tire peripheral direction intersect in opposite directions to each other between the plies. An organic fiber such as polyester, rayon, nylon or aramid, and metal such as steel are preferably used for the belt cord.

The belt reinforcing portion 82 is arranged so as to cover the belt layer 81 over the tire width direction. Further, the belt reinforcing portion 82 is provided with a reinforcing cord, and a topping rubber which covers the reinforcing cord. In the present embodiment, the belt reinforcing portion 82 is provided with two reinforcing plies 82a and 82b, and is constructed as a two-layer structure.

At least one reinforcing cord covered with the topping rubber is wound spirally (at an angle of incline between 0 degrees and 5 degrees in relation to the tire peripheral direction) along the tire peripheral direction, and the belt reinforcing portion 82 is accordingly formed. The organic fiber such as polyester, rayon, nylon or aramid is preferably used for the reinforcing cord.

The cushion rubber 9 is arranged between an end portion in an outward side in the tire width direction of the belt layer 81 and the carcass layer 5. Further, a dimension in the tire diametrical direction of the cushion rubber 9 is enlarged toward an outer side in the tire diametrical direction. Specifically, the cushion rubber 9 is formed so that a cross sectional shape obtained by cutting along the tire diametrical direction is a triangular shape.

The modulus of the cushion rubber 9 is smaller than the modulus of the cap rubber 74 in the tread rubber 7. Specifically, 100% tensile modulus of the cushion rubber 9 is smaller than 100% tensile modulus of the cap rubber 74. Note that the 100% tensile modulus is set to 100% tensile modulus which is measured at 23° C. in accordance with JISK6251.

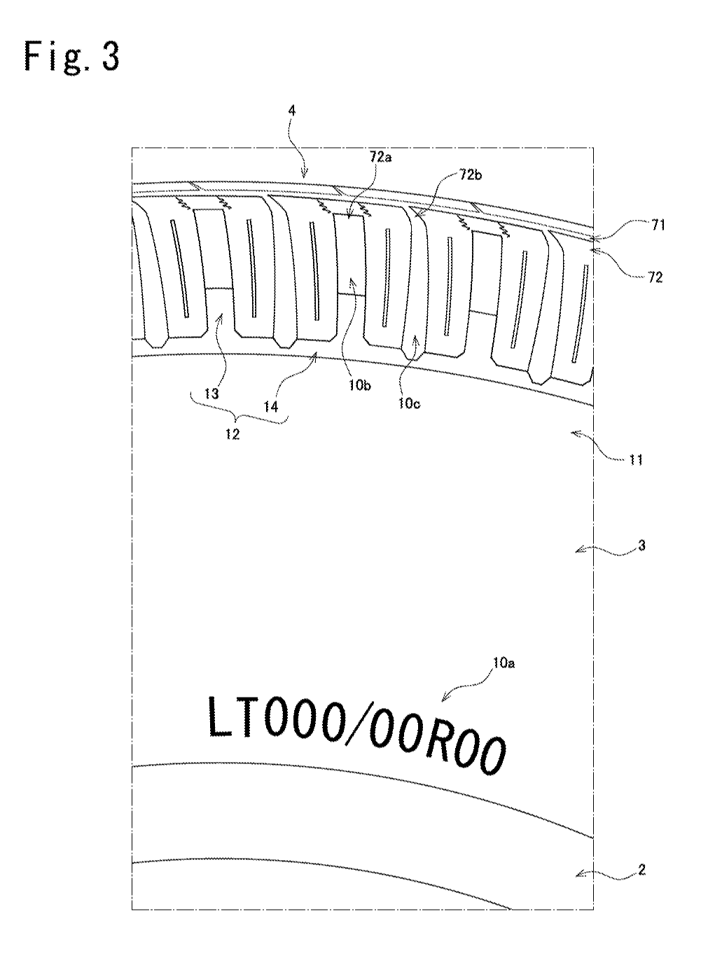

The side wall portion 3 is provided with a side wall rubber 10 which is arranged in an outer side in the tire width direction of the carcass layer 5 for constructing a tire outer surface, as shown in FIGS. 2 and 3. The side wall rubber 10 is provided with a display portion 10a which displays information or the like relating to the tire, for example, letters, numerals and figures.

In the present embodiment, the display portion 10a includes the letters “LT”, and indicates that the tire 1 is provided for a light truck. For example, in a case where the size is 275/65R18, an outer diameter of the tire 1 is equal to or less than 829 mm. Further, a radius of an edge curved surface in the tire width direction of the tread portion 4 is, for example, between 1500 mm and 2500 mm. In other words, the tire 1 is formed into a square shape.

An end portion in an outward side in the tire diametrical direction of the side wall rubber 10 is connected to an end portion in an outward side in the tire width direction of the tread rubber 7. Specifically, the end portion in the outward side in the tire diametrical direction of the side wall rubber 10 is piled up to the end portion in the outward side in the tire width direction of the tread rubber 7 from the outer side in the tire width direction. In other words, the tire 1 is constructed as a side-on-tread (side wall-on-tread) structure in which the end portion of the side wall rubber 10 is mounted to the end portion of the tread rubber 7.

The side wall rubber 10 is provided with a wall rubber main body 11, and a protruding portion 12 which protrudes out of the wall rubber main body 11 toward an outward side in the tire width direction. Further, a top portion of the protruding portion 12 is formed into a flat shape.

The protruding portion 12 is provided with a plurality of first convex portions 13 which are arranged in parallel along the tire peripheral direction, and a second convex portion 14 which extends along the tire peripheral direction and is connected to the plurality of first convex portions 13. The first convex portion 13 is formed into a rectangular shape in a side elevational view, and the second convex portion 14 is formed into an annular shape in a side elevational view.

In the meantime, the tread rubber 7 is provided with a first transverse groove 72a which extends along an outward side from an intermediate portion in the tire width direction of a shoulder side land portion 72, and a second transverse groove 72b which extends along an outward side from an inner end portion in the tire width direction of the land portion 72. Further, the side wall rubber 10 is provided with a first side groove 10b which extends along the tire diametrical direction from an outer end in the tire diametrical direction so as to be connected to the first transverse groove 72a, and a second side groove 10c which extends along the tire diametrical direction from an outer end in the tire diametrical direction so as to be connected to the second transverse groove 72b.

Meanwhile, the plurality of first convex portions 13 are separated from each other in the tire peripheral direction and are arranged so as to correspond to the positions of the first side grooves 10b. Specifically, an outer end in the tire diametrical direction of the first convex portion 13 is connected to an inner end in the tire diametrical direction of the first side groove 10b.

Further, the second convex portion 14 is connected to an inner end in the tire diametrical direction of the first convex portion 13. Further, the second convex portion 14 is arranged so as to overlap with, an inner end in the tire diametrical direction of the cushion rubber 9 in the tire width direction.

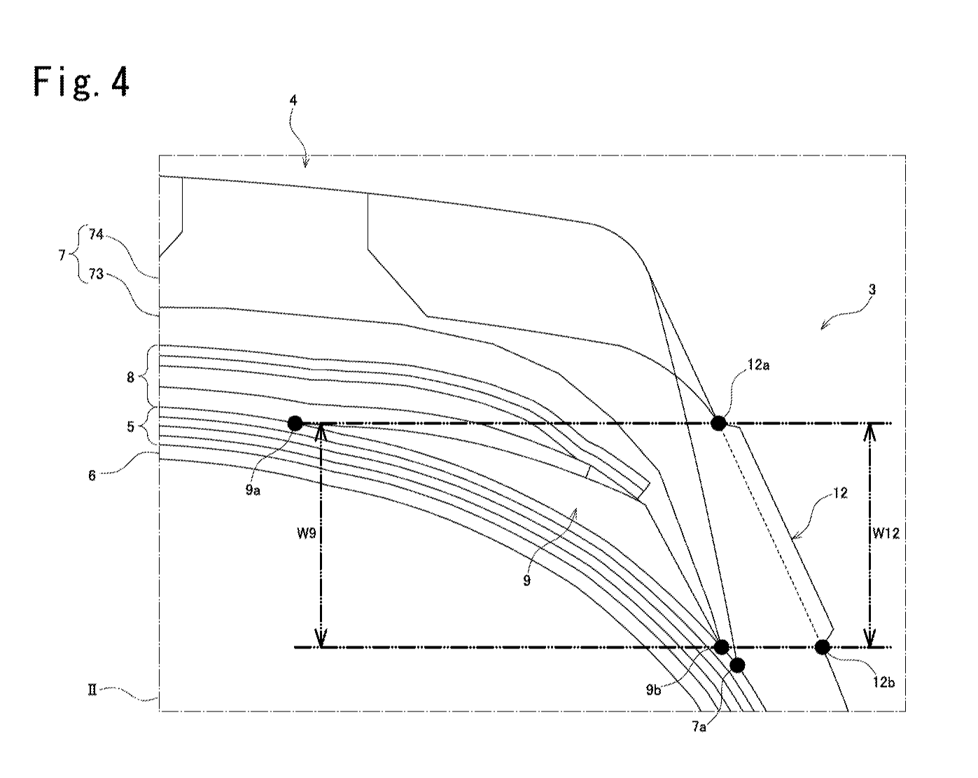

As shown in FIG. 4, an outer end 12a in the tire diametrical direction of the protruding portion 12 is arranged at the same position as an outer end 9a in the tire diametrical direction of the cushion rubber 9. Further, an inner end 12b in the tire diametrical direction of the protruding portion 12 is arranged at the same position as an inner end 9b in the tire diametrical direction of the cushion rubber 9.

As a result, the protruding portion 12 is arranged so as to overlap with the cushion rubber 9 in the width direction in its entirety. In other words, a dimension W12 in the tire diametrical direction of the protruding portion 12 is the same as a dimension W9 in the tire diametrical direction of the cushion rubber 9.

As mentioned above, the pneumatic tire 1 according to the present embodiment is provided with the carcass layer 5 which is arranged along the tire inner periphery, the belt layer 81 which is arranged in the outer side in the tire diametrical direction of the carcass layer 5, the tread rubber 7 which has the cap rubber 74 constructing the tread surface, and is arranged in the outer side in the tire diametrical direction of the belt layer 81, the side wall rubber 10 whose end portion in the outward side in the tire diametrical direction is connected to the end portion in the outward side in the tire width direction of the tread rubber 7, and the cushion rubber 9 which is arranged between the end portion in the outward side in the tire width direction of the belt layer 81 and the carcass layer 5, and has the smaller modulus than the modulus of the cap rubber 74. The side wall rubber 10 is provided with the protruding portion 12 which protrudes toward the outward side in the tire width direction, the dimension W12 in the tire diametrical direction of the protruding portion 12 is equal to or less than (specifically equal to) the dimension W9 in the tire diametrical direction of the cushion rubber 9, the protruding portion 12 is arranged so as to overlap with the cushion rubber 9 in the tire width direction at least partially, and the outer end 12a in the tire diametrical direction of the protruding portion 12 is arranged at the same position as the outer end 9a in the tire diametrical direction of the cushion rubber 9 or closer to the inner side in the tire diametrical direction than the outer end 9a (specifically at the same position).

According to the structure mentioned above, the modulus of the cushion rubber 9 is smaller than the modulus of the cap rubber 74. On the contrary, the side wall rubber 10 is provided with the protruding portion 12 which protrudes toward the outward, side in the tire width direction. Further, the dimension W12 in the tire diametrical direction of the protruding portion 12 is equal to or less than (specifically equal to) the dimension in the tire diametrical direction of the cushion rubber 9. As a result, since the rubber weight caused by the protruding portion 12 is inhibited from increasing too much, the rolling resistance is inhibited from increasing.

Further, at least a part of the protruding portion 12 overlaps with the cushion rubber 9 in the tire width direction. Further, the outer end 12a in the tire diametrical direction of the protruding portion 12 is arranged at the same position as the outer end 9a in the tire diametrical direction of the cushion rubber 9 or closer to the inner side in the tire diametrical direction than the outer end 9a (specifically at the same position). As a result, since the protruding portion 12 reinforces an area in which rigidity is lowered due to the cushion rubber 9, it is possible to improve steering stability.

Further, in the pneumatic tire 1 according to the present embodiment, it is structured such that the end portion in the outward side in the tire diametrical direction of the side wall rubber 10 is piled up to the end portion in the outward side in the tire width direction of the tread rubber 7 from the outer side in the tire width direction, and the inner end 12b in the tire diametrical direction of the protruding portion 12 is arranged at the same position as the inner end 7a in the tire diametrical direction of the tread rubber 7 or closer to the outer side in the tire diametrical direction than the inner end 7a (specifically closer to the outer side in the tire diametrical direction).

According to the structure mentioned above, the inner end 12b in the tire diametrical direction of the protruding portion 12 is arranged at the same position as the inner end 7a in the tire diametrical direction of the tread rubber 7 or closer to the outer side in the tire diametrical direction than the inner end 7a (specifically closer to the outer side in the tire diametrical direction). As a result, since the protruding portion 12 reinforces the area in which the rigidity is lowered due to the cushion rubber 9, it is possible to improve the steering stability.

Further, in the pneumatic tire 1 according to the present embodiment, it is structured such that the protruding portion 12 is arranged so as to overlap with the cushion rubber 9 in the tire width direction in their entirety.

According to the structure mentioned above, since the protruding portion 12 overlaps with the cushion rubber 9 in the tire width direction in its entirety, the protruding portion 12 effectively reinforces the area in which the rigidity is lowered due to the cushion rubber 9. As a result, it is possible to further improve the steering stability.

Further, in the pneumatic tire I according to the present embodiment, it is structured such that the protruding portion 12 is provided with the plurality of first convex portions 13 which are arranged in parallel along the tire peripheral direction, and the second convex portion 14 which extends along the tire peripheral direction and is connected to the plurality of first convex portions 13.

According to the structure mentioned above, the protruding portion 12 is provided with the plurality of first convex portions 13 which are arranged in parallel along the tire peripheral direction. As a result, it is possible to effectively reinforce the area in which the rigidity is lowered due to the cushion rubber 9 while inhibiting the rubber weight from increasing too much, by arranging the first convex portions 13 at the positions which are necessary to be reinforced.

Further, the protruding portion 12 is provided with the second convex portion 14 which extends in the tire peripheral direction and is connected to the plurality of first convex portions 13. As a result, it is possible to reinforce the area in which the rigidity is lowered due to the cushion rubber 9 not only in relation to the deformation in the tire width direction but also in relation to the deformation in the tire peripheral direction.

Further, in the pneumatic tire 1 according to the present embodiment, it is structured such that the side wall rubber 10 is provided with the side groove (specifically the first side groove) 10b which extends along the tire diametrical direction from the outer end in the tire diametrical direction, and the first convex portion 13 is connected to the inner end in the tire diametrical direction of the side groove (specifically the first side groove) 10b.

According to the structure mentioned above, since the first convex portions 13 are connected to the inner end in the tire diametrical direction of the side groove 10b which extends along the tire diametrical direction from the outer end in the tire diametrical direction, it is possible to effectively reinforce the area in which the rigidity is lowered due to the side groove 10b. As a result, it is possible to reinforce the area in which the rigidity is lowered due to the side groove 10b while inhibiting the rubber weight from increasing too much, by arranging the first convex portions 13 at the positions which are necessary to be reinforced.

Further, in the pneumatic tire 1 according to the present embodiment, it is structured such that the second convex portion 14 is connected to the inner ends in the tire diametrical direction of the first convex portions 13, and is arranged so as to overlap with the inner end 9b in the tire diametrical direction of the cushion rubber 9 in the tire width direction.

According to the structure mentioned above, the second convex portion 14 is connected to the inner ends in the tire diametrical direction of the first convex portions 13 and is arranged so as to overlap with the inner end 9b in the tire diametrical direction of the cushion rubber 9 in the tire width direction. As a result, it is possible to effectively reinforce the area in which the rigidity is particularly lowered due to the cushion rubber 9, specifically the area of the inner end 9b in the tire diametrical direction of the cushion rubber 9.

The pneumatic tire is not limited to the configuration of the embodiment described above, and the effects are not limited to those described above. It goes without saying that the pneumatic tire can be variously modified without departing from the scope of the subject matter of the present invention. Not to mention, the configurations and methods or the like according to various modification examples described below, for example, may be freely selected and adopted to the configurations or methods of the embodiment described above.

In the pneumatic tire according to the embodiment, it is structured such that the protruding portion 12 is arranged so as to over lap with the cushion rubber 9 in the tire width direction in its entirety. However, the pneumatic tire is not limited to the structure. For example, the pneumatic tire may be structured, as shown in FIG. 5, such that the protruding portion 12 is arranged so as to overlap with the cushion rubber 9 in the tire width direction partly. In the tire according to FIG. 5, the dimension W12 in the tire diametrical direction of the protruding portion 12 is the same as the dimension W9 in the tire diametrical direction of the cushion rubber 9.

Further, in the pneumatic tire according to the above embodiment, it is structured such that the outer end 12a in the tire diametrical direction of the protruding portion 12 is arranged at the same position as the outer end 9a in the tire diametrical direction of the cushion rubber 9. However, the pneumatic tire is not limited to the structure. For example, the pneumatic tire may be structured, as shown in FIG. 5, such that the outer end 12a in the tire diametrical direction of the protruding portion 12 is arranged closer to the inner side in the tire diametrical direction than the outer end 9a in the tire diametrical direction of the cushion rubber 9.

Further, in the pneumatic tire according to the above embodiment, it is structured such that the inner end 12b in the tire diametrical direction of the protruding portion 12 is arranged closer to the outer side in the tire diametrical direction than the inner end 7a in the tire diametrical direction of the tread rubber 7. However, the pneumatic tire is not limited to the structure. For example, the pneumatic tire may be structured, as shown in FIG. 5, such that the inner end 12b in the tire diametrical direction of the protruding portion 12 is arranged at the same position as the inner end 7a in the tire diametrical direction of the tread rubber 7.

Further, in the pneumatic tire according to the above embodiment, it is structured such that the dimension W12 in the tire diametrical direction of the protruding portion 12 is the same as the dimension W9 in the tire diametrical direction of the cushion rubber 9. However, the pneumatic tire is not limited to the structure. For example, the pneumatic tire may be structured such that the dimension W12 in the tire diametrical direction of the protruding portion 12 is smaller than the dimension W9 in the tire diametrical direction of the cushion rubber 9.

Further, in the pneumatic tire according to the above embodiment, it is structured such that the protruding portion 12 is provided with the plurality of first convex portions 13 which are arranged in parallel along the tire peripheral direction, and the second convex portion 14 which extends along the tire peripheral direction. However, the pneumatic tire is not limited to the structure. For example, the pneumatic tire may be structured such that the protruding portion 12 is provided with only the convex portions which are arranged along the tire peripheral direction (that is, convex portions which are intermittently arranged), and may be structured such that the protruding portion 12 is provided with only the convex portion which extends along the tire peripheral direction (that is, the convex portion which is continuously arranged).

Further, in the pneumatic tire according to the above embodiment, it is structured such that the first convex portions 13 are connected to the first side grooves 10b. However, the pneumatic tire is not limited to the structure. For example, the pneumatic tire may be structured such that the first convex portions 13 are connected to both of the first and second side grooves 10b and 10c, may be structured such that the first convex portions 13 are connected only to the second side groove 10c, or may be structured such that the first convex portions 13 are spaced from both of the first and second side grooves 10b and 10c in the tire diametrical direction.

Further, in the pneumatic tire according to the above embodiment, it is structured such that the second convex portion 14 is connected to the inner ends in the tire diametrical direction of the first convex portions 13. However, the pneumatic tire is not limited to the structure. For example, the pneumatic tire may be structured such that the second convex portion 14 is connected to the outer ends in the tire diametrical direction of the first convex portions 13, or may be structured such that the second convex portion 14 is connected to intermediate portions in the tire diametrical direction of the first convex portions 13.

Further, in the pneumatic tire according to the above embodiment, it is structured such that the second convex portion 14 is arranged so as to overlap with the inner end 9b in the tire diametrical direction of the cushion rubber 9 in the tire width direction. However, the pneumatic tire is not limited to the structure. For example, the pneumatic tire may be structured such that the second convex portion 14 is arranged so as not to overlap with the inner end 9b in the tire diametrical direction of the cushion rubber 9 in the tire width direction.

### EXAMPLES

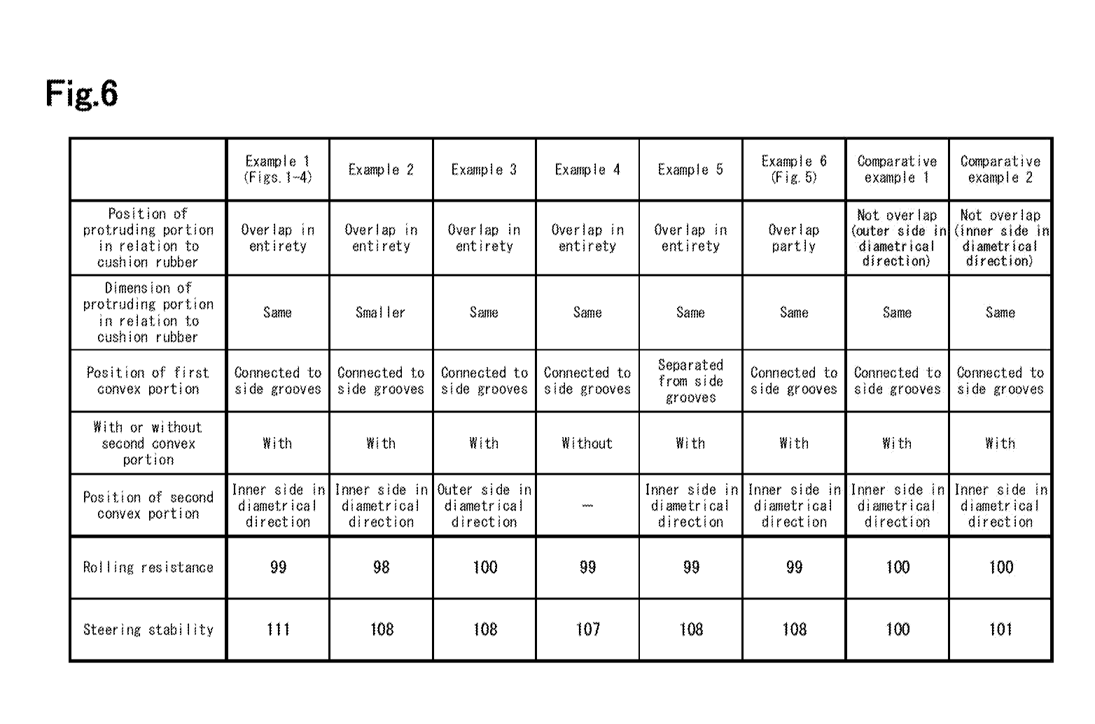

In order to specifically show the structure and the effect of the present invention, a description will be given below of examples and comparative examples of the pneumatic tire with reference to FIG. 6.

### <Rolling Resistance>

Each of tires having a size of 275/65R18 was assembled in a rim, was thereafter filled with an internal pressure of 50 psi (a pneumatic pressure corresponding to a single wheel maximum load capacity described in the side wall), and was measured its rolling resistance in accordance with International Standards ISO28580 (JIS D4234). Evaluation was made by an index number on the assumption that a result of comparative example 1 is 100. The smaller the index number is, the lower the rolling resistance is, which shows an excellent rolling resistance.

### <Steering Stability>

Each of tires having a size of 275/65R18 was installed to a vehicle, and turning travel on a dry road surface was executed. Further, steering stability was evaluated according to a feeling test by a driver. The evaluation was made by an index number on the assumption that a result of comparative example 1 is 100. The greater the index number, the more excellent the steering stability exhibits.

### EXAMPLES 1 TO 6

Example 1 is a tire according to the above embodiment in FIGS. 1 to 4.

Example 2 is a tire which is changed to a structure in which the dimension W12 in the tire diametrical direction of the protruding portion 12 is smaller than the dimension W9 in the tire diametrical direction of the cushion rubber 9, in relation to the tire according to example 1.

Example 3 is a tire which is changed to a structure in which the second convex portion 14 is connected to the outer ends in the tire diametrical direction of the first convex portions 13, in relation to the tire according to example 1.

Example 4 is a tire which is changed to a structure in which the protruding portion 12 is provided with only the convex portions (the intermittently arranged convex portions) 13 which are arranged in parallel along the tire peripheral direction, in relation to the tire according to example 1.

Example 5 is a tire which is changed to a structure in which the first convex portions 13 are spaced from the first side grooves 10b, in relation to the tire according to example 1.

Example 6 is a tire, according to FIG. 5, which is changed to a structure in which a part of the protruding port ion 12 overlaps with the cushion rubber 9 in the tire width direction, in relation to the tire according to example 1.

### COMPARATIVE EXAMPLES 1 AND 2>

Comparative example 1 is a tire which is changed to a structure in which the protruding portion 12 is arranged closer to the outer side in the tire diametrical direction than the cushion rubber 9, and the protruding portion 12 does not overlap with the cushion rubber 9 in the tire width direction, in relation to the tire according to example 1.

Comparative example 2 is a tire which is changed to a structure in which the protruding portion 12 is arranged closer to the inner side in the tire diametrical direction than the cushion rubber 9, and the protruding portion 12 does not overlap with the cushion rubber 9 in the tire width direction, in relation to the tire according to example 1.

### <Results of Evaluation>

In examples 1 to 6, the steering stability can be improved without increase of the rolling resistance, in comparison with comparative examples 1 and 2. Since the dimension W12 in the tire diametrical direction of the protruding portion 12 is equal to or less than the dimension W9 in the tire diametrical direction of the cushion rubber 9, at least apart of the protruding portion 12 is arranged so as to overlap with the cushion rubber 9 in the tire width direction, and the outer end 12a in the tire diametrical direction of the protruding portion 12 is arranged at the same position as the outer end 9a in the tire diametrical direction of the cushion rubber 9 or closer to the inner side in the tire diametrical direction than the outer end 9a, as mentioned above, it is possible to improve the steering stability while inhibiting the rolling resistance from increasing.

Further, a description will be given below of more preferable examples of the tire.

First of all, in the tire according to example 1, it is structured such that the second convex portion 14 is connected to the inner ends in the tire diametrical direction of the first convex portions 13. On the other hand, in the tire according to example 3, it is structured such that the second convex portion 14 is connected to the outer ends in the tire diametrical direction of the first convex portions 13.

Further, it is possible to improve the steering stability in the tire according to example 3, and it is possible to very effectively improve the steering stability in the tire according to example 1. As a result, the tire is preferably structured such that the second convex portion 14 is connected to the inner ends in the tire diametrical direction of the first convex portions 13.

Further, in the tire according to example 1, it is structured such that the protruding portion 12 is provided with the first convex portions 13 which are arranged in parallel along the tire peripheral direction, and the second convex portion 14 which extends in the tire peripheral direction. On the other hand, in the tire according to example 4, it is structured such that the protruding portion 12 is provided with only the convex portions (the intermittently arranged convex portions) 13 which are arranged in parallel along the tire peripheral direction.

Further, it is possible to improve the steering stability in the tire according to example 4, and it is possible to very effectively improve the steering stability in the tire according to example 1. As a result, the tire is preferably structured such that the protruding portion 12 is provided with the first convex portions 13 which are arranged in parallel along the tire peripheral direction, and the second convex portion 14 which extends in the tire peripheral direction.

Further, in the tire according to example 1, it is structured such that the first convex portions 13 are connected to the side grooves 10b. On the other hand, in the tire according to example 5, it is structured such that the first convex portions 13 are spaced from the side grooves 10b.

Further, it is possible to improve the steering stability in the tire according to example 5, and it is possible to very effectively improve the steering stability in the tire according to example 1. As a result, the tire is preferably structured such that the first convex portions 13 are connected to the side grooves 10b.

Further, in the tire according to example 1, it is structured such that the protruding portion 12 overlaps with the cushion rubber 9 in the tire width direction in its entirety. On the other hand, in the tire according to example 6, it is structured such that a part of the protruding portion 12 overlaps with the cushion rubber 9 in the tire width direction.

Further, it is possible to improve the steering stability in the tire according to example 6, and it is possible to very effectively improve the steering stability in the tire according to example 1. As a result, the tire is preferably structured such that the protruding portion 12 overlaps with the cushion rubber 9 in the tire width direction in its entirety.

What is claimed is:

1. A pneumatic tire comprising:
a carcass layer which is arranged along a tire inner periphery;
a belt layer which is arranged in an outer side in a tire diametrical direction of the carcass layer;
a tread rubber which has a cap rubber constructing a tread surface and is arranged in an outer side in the tire diametrical direction of the belt layer;
side wall rubbers whose end portions in outward sides in the tire diametrical direction are connected to end portions in outward sides in a tire width direction of the tread rubber; and
cushion rubbers which are arranged between end portions in outward sides in the tire width direction of the belt layer and the carcass layer, and have a smaller modulus than a modulus of the cap rubber,
wherein the side wall rubber has protruding portion which protrudes toward outward side in the tire width direction,
a dimension in the tire diametrical direction of the protruding portion is equal to or less than a dimension in the tire diametrical direction of the cushion rubber,
the protruding portion is arranged so as to overlap with the cushion rubber in the tire width direction at least partly, and
outer end in the tire diametrical direction of the protruding portion is arranged at the same position as outer end in the tire diametrical direction of the cushion rubber or closer to inner side in the tire diametrical direction than the outer end in the tire diametrical direction of the cushion rubber.

2. The pneumatic tire according to claim 1, wherein
end portion in outward sides in the tire diametrical direction of the side wall rubber is piled up to end portion in outward side in the tire width direction of the tread rubber from outer side in the tire width direction, and
inner end in the tire diametrical direction of the protruding portion is arranged at the same position as inner end in the tire diametrical direction of the tread rubber or closer to outer side in the tire diametrical direction than the inner end in the tire diametrical direction of the tread rubber.

3. The pneumatic tire according to claim 1, wherein
the protruding portion is arranged so as to overlap with the cushion rubber in the tire width direction in their entirety.

4. The pneumatic tire according to claim 1, wherein
the protruding portion is provided with a plurality of first convex portions which are arranged in parallel along a tire peripheral direction, and a second convex portion which extends along the tire peripheral direction and is connected to the plurality of first convex portions.

5. The pneumatic tire according to claim 4, wherein
the side wall rubber is provided with a side groove which extends along the tire diametrical direction from the outer end in the tire diametrical direction, and
the first convex portions are connected to an inner end in the tire diametrical direction of the side groove.

6. The pneumatic tire according to claim 5, wherein
the second convex portion is connected to inner ends in the tire diametrical direction of the first convex portions, and is arranged so as to overlap with an inner end in the tire diametrical direction of the cushion rubber in the tire width direction.
